(19) United States
(12) Patent Application Publication
(10) Pub. No.: US 2024/0344660 A1
(43) Pub. Date: Oct. 17, 2024

(54) FLUID-STORAGE TANK

(71) Applicant: H3 DYNAMICS HOLDINGS PTE. LTD., SINGAPORE (SG)

(72) Inventor: Taras WANKEWYCZ, SINGAPORE (SG)

(21) Appl. No.: 18/698,725

(22) PCT Filed: Oct. 4, 2022
(86) PCT No.: PCT/IB2022/059442

§ 371 Date: Apr. 4, 2024

(30) Foreign Application Priority Data
Oct. 4, 2021 (SG) 10202111025S

(51) Int. Cl. F17C 1/04; B64D 37/04

(52) U.S. Cl. CPC F17C 1/04; B64D 37/04; F17C 2201/0166; F17C 2201/0171; F17C 2203/012; F17C 2203/0619; F17C 2203/0636; F17C 2203/0658; F17C 2205/0323; F17C 2221/012; F17C 2270/0134; F17C 2270/0168; F17C 2270/0189

(57) ABSTRACT

Fluid storage tank, comprising at least one layer, wherein the at least one layer encloses at least one chamber, further comprising a valve, the valve connecting an interior of the at least one chamber with an exterior of the at least one chamber, wherein the fluid storage tank is made at least partially by means of 3D-printing.

The present application relates to a fluid storage tank, and in particular to a fluid storage tank, which is at least partially made by means of 3D-printing.

Zacc Dukowitz, “Airbus Announces Plans to 3D Print Drones and Self-Driving Cars”, https://uavcoach.com/airbus-3d-printing, 16 Oct. 2019, discloses that vehicles, e.g. drones and self-driving cars are made using 3D printers.

WO 2020/060488 A1 discloses an autonomous refuelling vehicle for a hydrogen-electric aircraft.

It is an object of the present application to provide an improved tank for storing fluids for various applications.

It is a further object of the present application to provide a tank for fluids which can easily be manufactured.

It is a further object of the present application to provide a tank for fluids which can easily be transported.

In one aspect of this specification, there is proposed a fluid storage tank comprising at least one layer, wherein the at least one layer encloses at least one chamber, further comprising a valve, the valve connecting an interior of the at least one chamber with an exterior of the at least one chamber, wherein the fluid storage tank is made at least partially by means of 3D-printing. In this way a single layer provides stability and ability to store a fluid within the proposed fluid storage tank. By means of 3D-printing, said proposed fluid storage tank can be manufactured easily and cost-effective.

A fluid storage tank according to the present specification can provide desired properties for storing a fluid with a stabilizing layer being manufactured at least partially by means of 3D-printing.

A preferred embodiment of the fluid storage tank is characterized by at least two layers, wherein the layers are at least partially arranged on top of each other, wherein a first layer provides stability and a second layer provides tightness for the fluid. In this way, the characteristics “stability” and “tightness” can be functionally separated from each other, so that optimized layers can be provided by 3D-printing with respect to said characteristics. Summarizing, improved utilization properties for the fluid storage tank are supported thereby.

In a further embodiment, the present specification discloses a fluid storage tank which comprises a defined number of chambers greater than one, wherein the chambers are separated from each other or are at least partially connected with each other by connection lines. In this way there are provided various ways to arrange the chambers of the fluid storage tank with respect to each other, thus providing means for a fluid communication of the fluid within the fluid storage tank.

A further embodiment of the fluid storage tank proposes, that the 3D-printed fluid storage tank is characterized in that also the valve is 3D-printed. Therefore, complete fluid storage system including means for filling/refilling/letting out a fluid can be provided by means of 3D-printing. Optimized manufacturing processes are supported thereby.

In a further embodiment, the fluid storage tank comprises further a thread for fixing the valve. Said thread can also easily be manufactured via 3D-printing.

In a further embodiment, the fluid storage tank is characterized in that the valve is glued in an opening of the at least one layer. In this way, an alternative possibility to fasten the valve to the 3D-printed fluid storage tank is provided.

A further embodiment of the fluid storage tank is characterized in that the connection lines between the chambers are irregularly structured. In this way, a preferred fluid flow direction can prevented as far as possible, thereby improving storage ability to store the fluid within the chambers.

A further embodiment proposes a digital membrane, which is at least partially arranged on at least one layer. By means of said digital membrane, numerous physical parameters can be measured, e.g. pressure, temperature, force, etc. An improved monitoring of the 3D-printed fluid storage tank is thus supported.

In a further embodiment it is proposed, that he valve is steerable by means of an electric signal provided by the digital membrane. Thus, a useful way to fill, refill or empty the chambers with filled-in fluid is provided. An automated operation of the fluid storage tank is supported in this manner.

In a further embodiment of the proposed fluid storage tank, at least one of the layers comprises a metallic material. By means of said metallic material, stability of the arrangement is enhanced.

A further embodiment of the proposed fluid storage fluid tank is characterized in that at least one of the layers comprises synthetic material, resin or the like. In this way, a fluid-tight layer is provided, wherein the fluid stored within the tank can be stored safely.

According to a further embodiment of the proposed fluid storage tank, it is proposed that the second layer is self-healing. In this way, also in a case, that the second layer is at least partially damaged, the leakage of the fluid within the tank can be reduced as far as possible.

A further embodiment of the proposed fluid storage tank is characterized by an enforcing structure being at least partially arranged on at least one layer. Thus, there is provided enforcing structure, which provides further improved stability for the complete arrangement. Also in a case, that the first layer is damaged, the whole fluid storage tank can keep still functional and is able to store fluid within the fluid storage tank.

A further embodiment is characterized, in that the enforcing structure is a framework. Said framework can easily be produced, for example by means of a 3D-printing process.

A further embodiment of the proposed fluid storage tank is characterized in that the enforcing structure is at least partially built discrete. In this way, there are provided numerous possibilities to manufacture the enforcing structure from another process than 3D-printing, which can be implemented into the elements resulting from 3D-printing.

A further embodiment is characterized in that the enforcing structure is at least partially formed integrally with the layers. This can be done for example via a 3D-printing process, wherein all elements of the fluid storage tank are manufactured within the 3D-printing process.

A further embodiment is characterized in that the enforcing structure is honey-combed. Said honey-combed structure can easily be produced for example by means of the 3D-printing process. Therefore, an irregular formed enforcing structure is provided, thus providing a strong enforcing effect for the whole arrangement.

In yet a further embodiment of the proposed fluid storage tank is characterized in that further comprising at least one baffle plate in at least one chamber. By means of said baffle plate, the fluid stored within the tank is kept stabilized and is therefore prevented from moving within the tank. Thus a stability of the whole 3D-printed fluid storage tank can be improved.

A further embodiment of the fluid storage tank is characterized in that it further comprises at least a sealing member for sealing at least one of the chambers. In this way, greater amounts of fluid the can be faster filled into the chamber, for example solid fluids.

A further embodiment is characterized in that the fluid storage tank is arranged in a vehicle. In this regard there are provided various ways to transport the fluid storage tank to different locations by means of the vehicle.

In yet another embodiment, the fluid storage tank is arranged in an aircraft. In this way, there is provided a fuel for the aircraft in the form of, e.g. pressurised hydrogen gas. Hydrogen-powered aircrafts can thus be manufactured easily.

In yet a further embodiment the 3D-printed fluid storage tank is arranged in at least a wing of the aircraft.

In yet a further embodiment, the fluid storage tank comprises a digital membrane, which is at least partially arranged between the first layer and the second layer. In this way, various flight conditions of the aircraft can be measured, therefore minimizing expenses for measurement tools and devices.

A further embodiment is characterized in that the fluid storage tank is arranged in a drone box. Said drone box can have a light-weight construction and can easily be filled e.g. with water, thus providing an isolation against heat and cold. In this way, both heated and cooled drone boxes can be realized.

A further embodiment is characterized in that the fluid storage tank is at least partially arranged at a facade of a building. Therefore, similar to the use case with the drone box, the 3D-printed fluid storage tank can be used to isolate, to heat and/or to cool a building, e.g. a high-rise building.

The subject matter of the specification can be applied to numerous types of tanks for fluids independent of their respective shapes and forms. The subject matter of the specification can also be applied to numerous types of fluids, be they e.g. gaseous or pressurized gases, liquids, solids or a mixture of them. The subject matter of the specification can also be applied to numerous types of material of the layers, e.g. metallic, synthetic with numerous properties, e.g. tight, anticorrosive, heat-resistant, etc.

The 3D-printed fluid storage tank can be made compact, light-weight and also portable, if needed. A fluid storage tank according to the present specification can e.g. be used to be transported to any accessible location. In general, the tank can be stationary or portable. Preferentially, the tank is sufficiently compact to be placed at a required location and sufficiently protected against environmental conditions, such as humidity, heat and corrosive substances.

Other objects and advantages of the present specification will become apparent from the following description, taken in connection with the accompanying drawings. By way of illustration and example, several embodiments of the proposed fluid storage tank are disclosed.

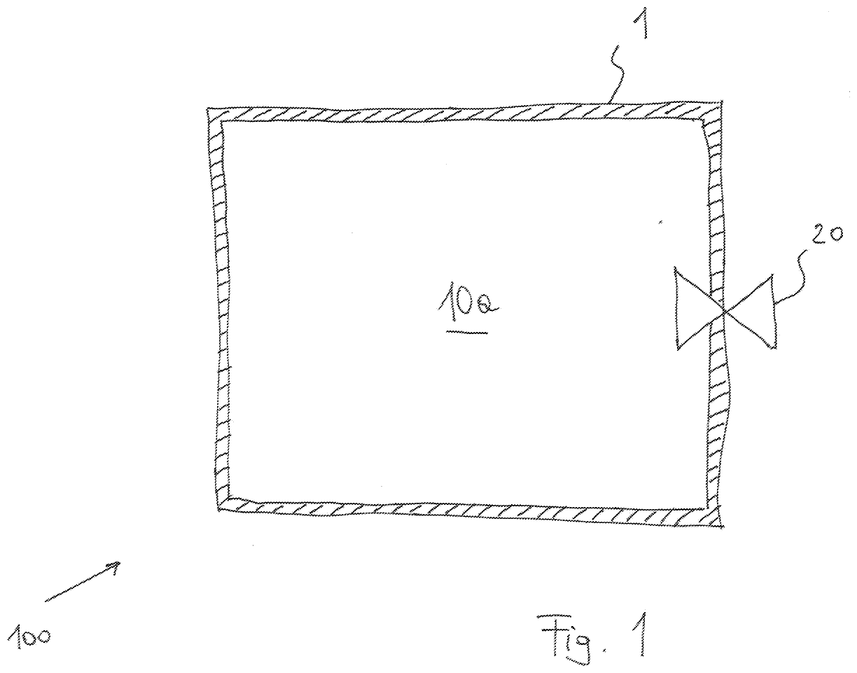

FIG. 1 is a cross-sectional view of a first embodiment of a fluid storage tank with one layer;

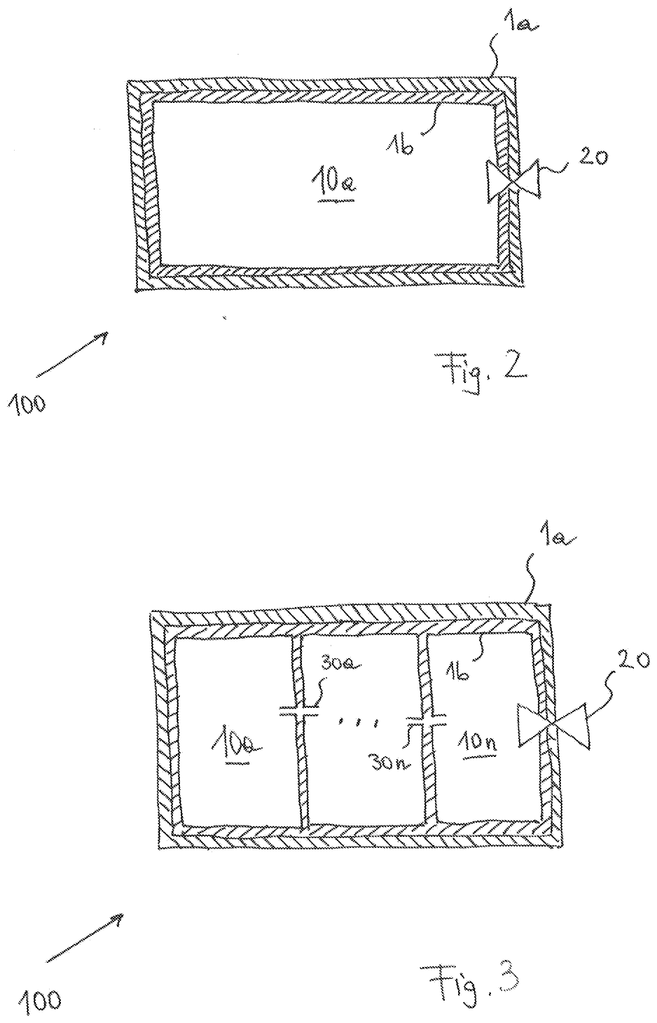

FIG. 2 is a cross-sectional view of a further embodiment of a fluid storage tank with two layers;

FIG. 3 is a cross-sectional view of a further embodiment of a fluid storage tank with multiple chambers being connected via connection lines,

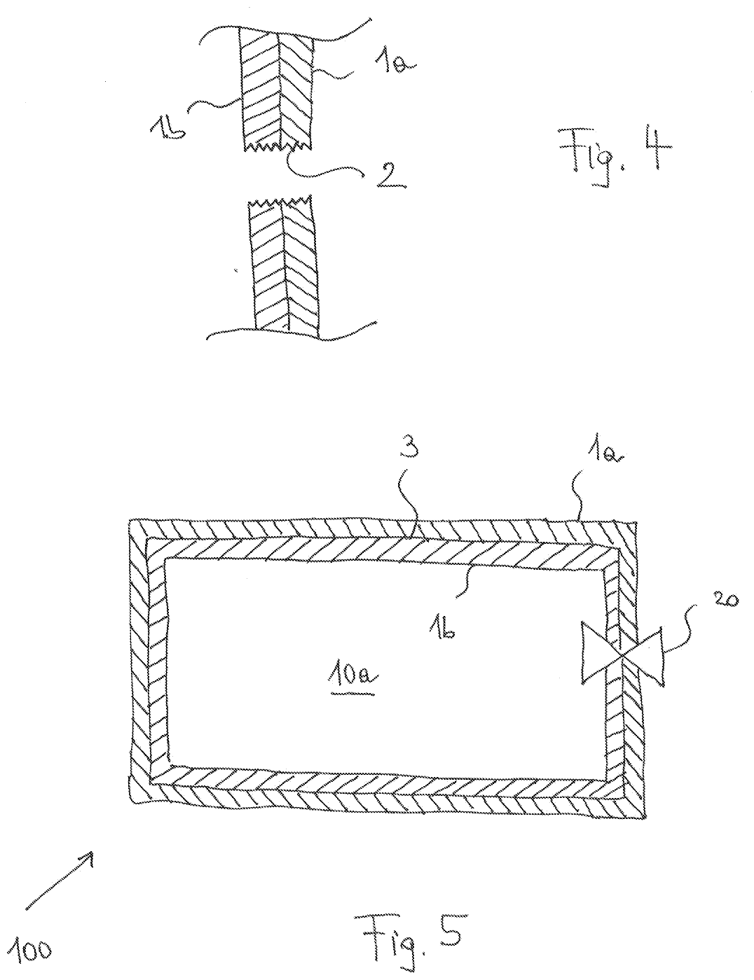

FIG. 4 shows a cross-sectional view of a thread within layers of a proposed fluid storage tank;

FIG. 5 is a cross-sectional view of a further embodiment of a fluid storage tank with a digital membrane;

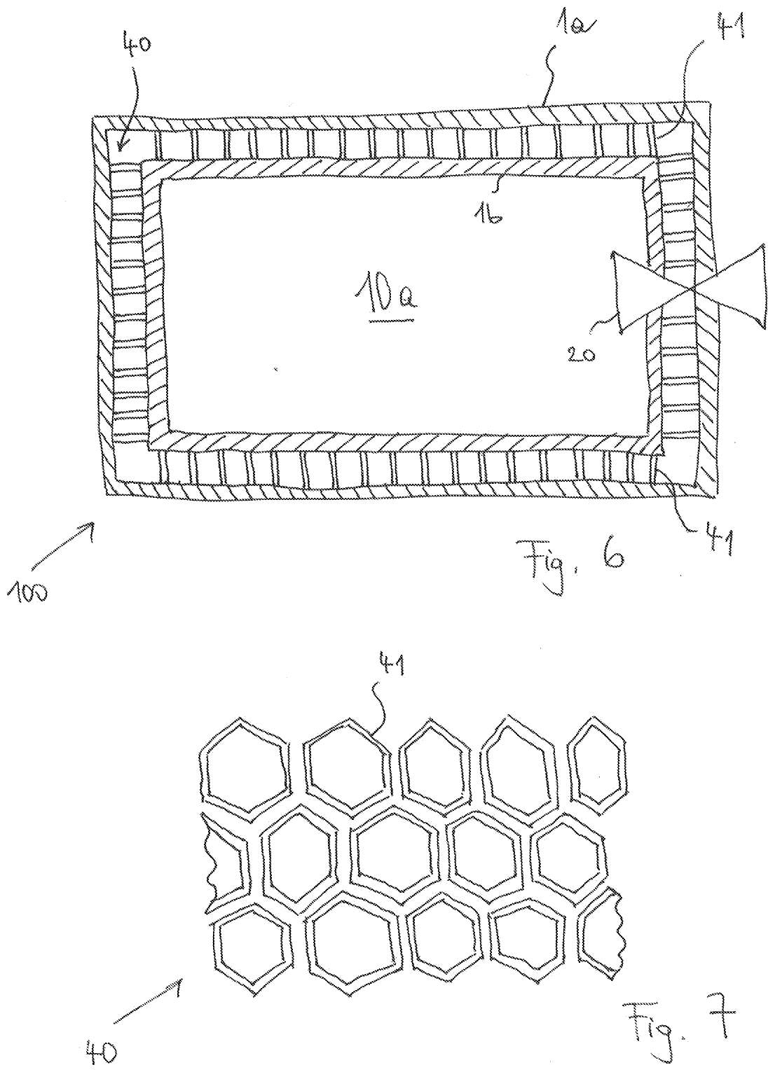

FIG. 6 is a cross-sectional view of a further embodiment of a fluid storage tank with an enforcing structure;

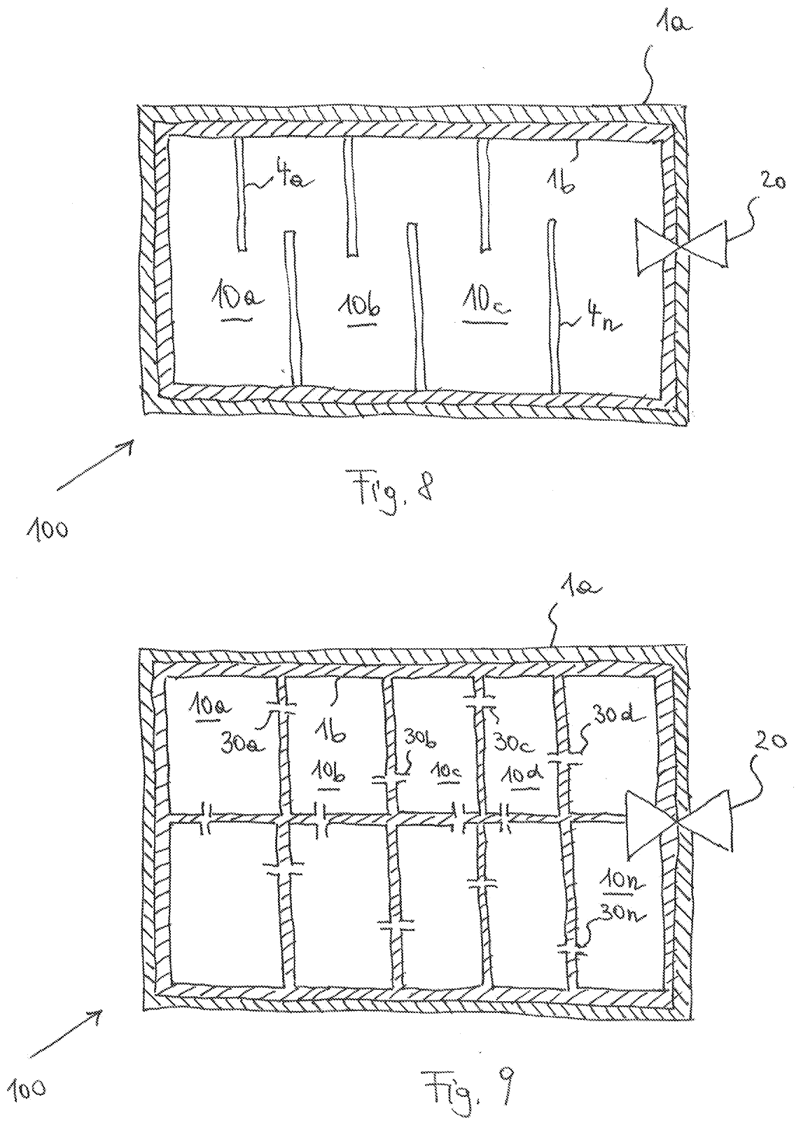

FIG. 7 shows an example of an enforcing structure for a proposed fluid storage tank;

FIG. 8 is a cross-sectional view of a further embodiment of a fluid storage tank with baffle plates;

FIG. 9 is a cross-sectional view of a further embodiment of a fluid storage tank with irregular structured connection lines;

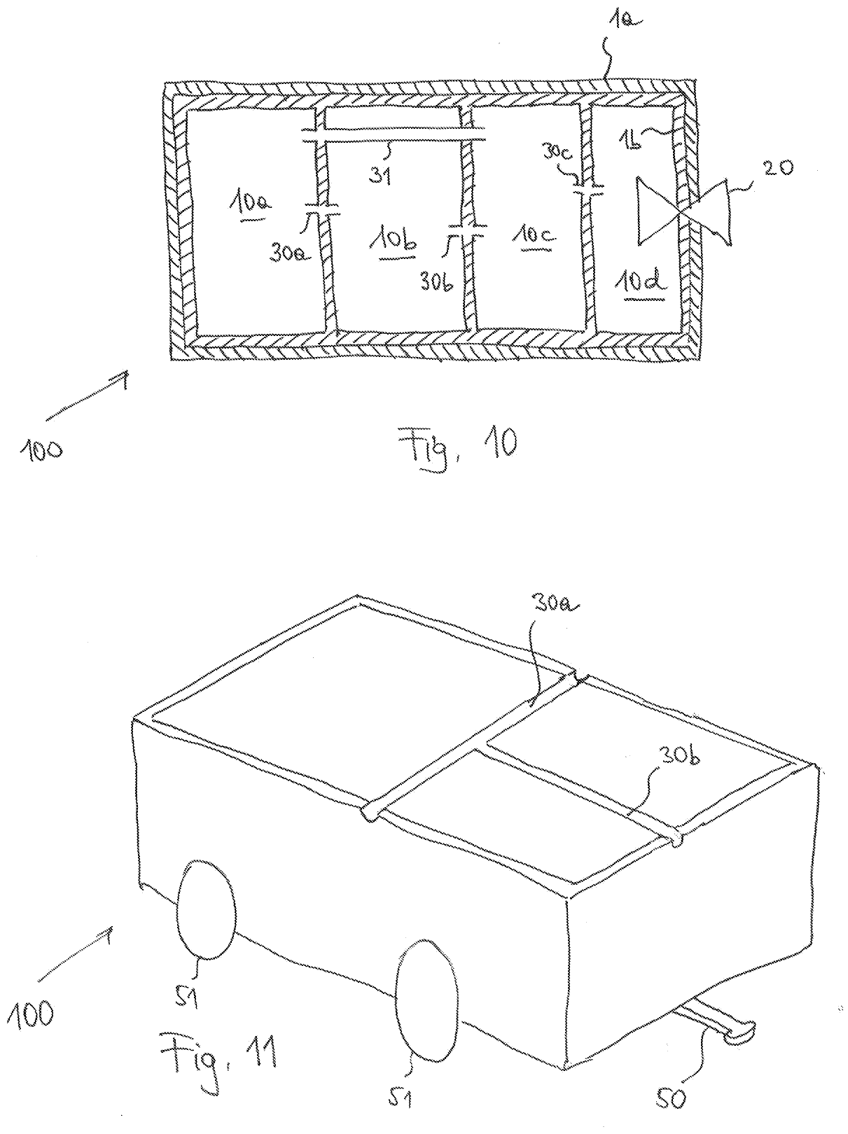

FIG. 10 is a cross-sectional view of a further embodiment of a fluid storage tank with a bridging line;

FIG. 11 is a perspective cross-sectional view of a further embodiment of a transportable fluid storage tank;

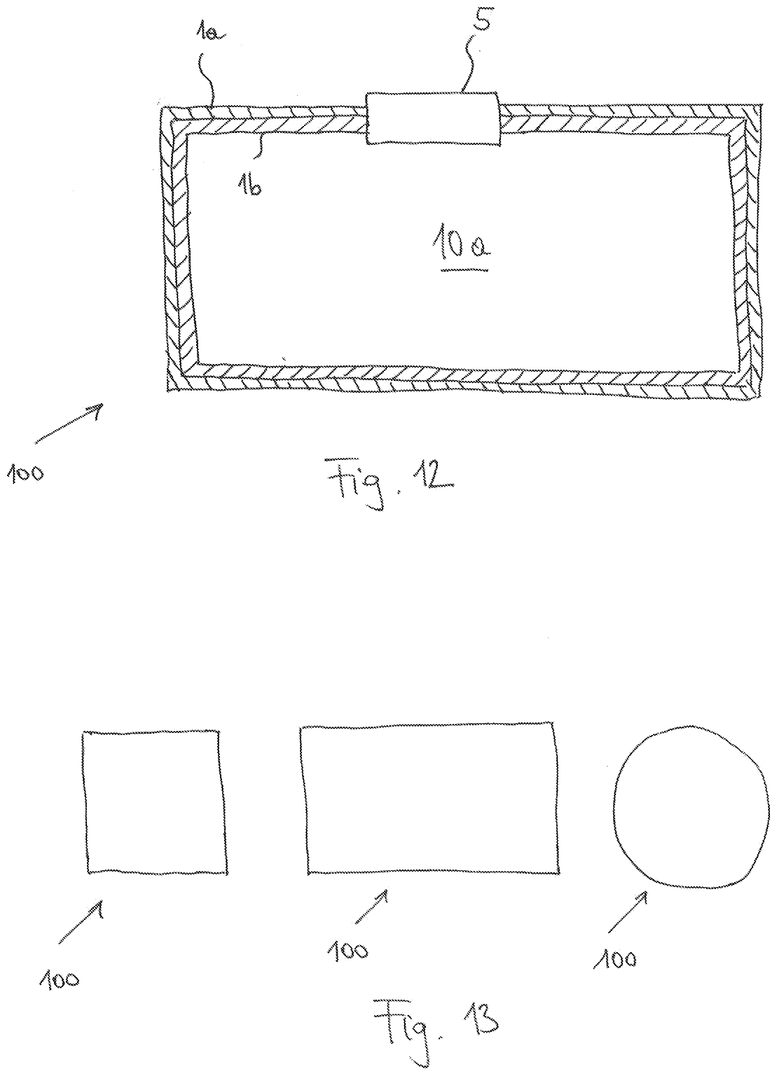

FIG. 12 is a perspective cross-sectional view of a further embodiment of a fluid storage tank;

FIG. 13 are top-views of three further embodiments of fluid storage tanks;

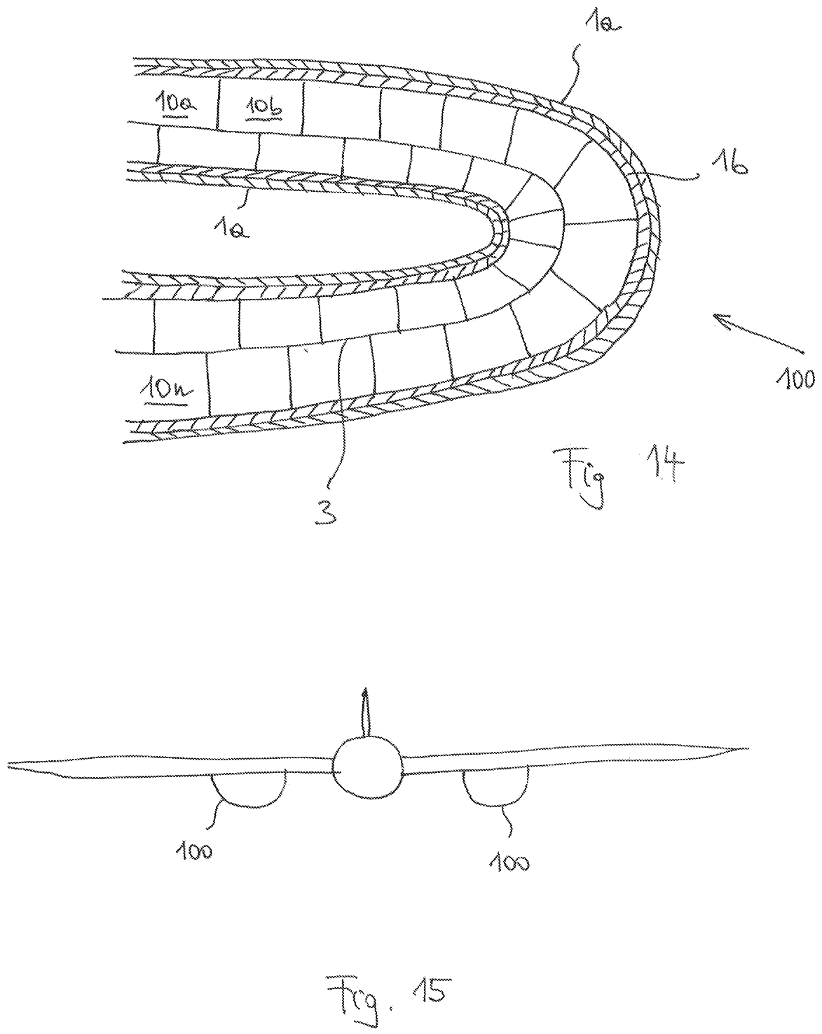

FIG. 14 is a cross-sectional view of a further embodiment of a fluid storage tank in a wing of an aircraft;

FIG. 15 shows an overview of an application of the embodiment of FIG. 14;

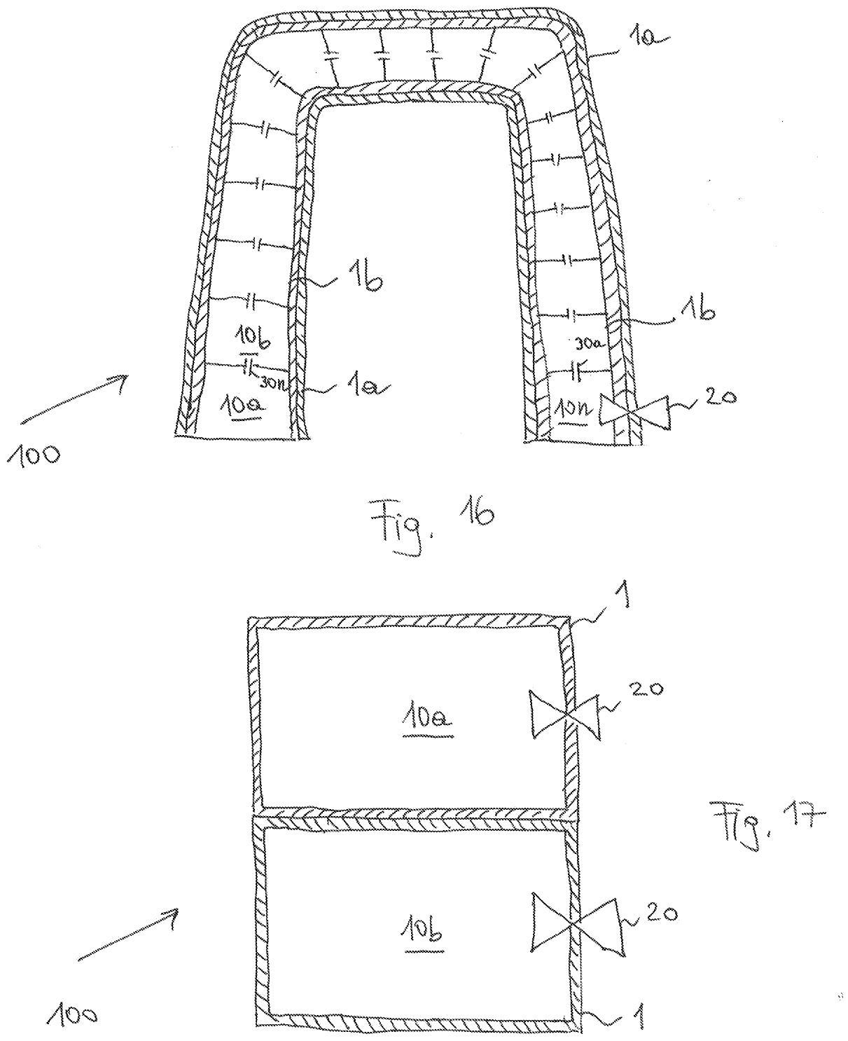

FIG. 16 is a cross-sectional view of a further embodiment of a fluid storage tank as a drone box;

FIG. 17 is a cross-sectional view of a further embodiment of a fluid storage tank with separated chambers.

The drawings are schematically and show principles of proposed fluid storage tanks and are not necessarily true-to-scale.

In the following description, like reference signs designate like or corresponding parts throughout the several views of the drawings.

The term “fluid” as used herein may refer to a liquid (e.g. water, pressurized gas), gas, multi-phase, solid, etc. and is not limited to any particular type of fluids, such as water (H₂O), gaseous or pressurized hydrogen (H₂), etc.

Although the term “tank” is used often in the present description, it stands for a tank for the storage of any fluid, be it gaseous and/or liquid and/or solid.

A 3D-printing process used to manufacture at least a part of the proposed fluid storage tank may include a computer aided design (CAD) module in operable communication with a 3D-printing module. Operable communication may be done via respective cabling, wireless, etc.

It should be noted that the following detailed description is directed to an at least partially 3D-printed fluid storage tank and applications for said fluid storage tank and is not limited to any particular size, form or configuration but in fact encompasses a multitude of sizes, forms and configurations within the scope of the following description.

Some parts of the embodiments, which are shown in the Figures, have similar parts. The similar parts have the same names or similar part numbers with a prime symbol or with an alphabetic symbol. The description of such similar parts also applies by reference to other similar parts, where appropriate, thereby reducing repetition of text without limiting the disclosure.

Referring now to FIG. 1, a cross-sectional view of a first embodiment of the proposed fluid storage tank 100 is shown. The fluid storage tank 100 is made at least partially by means of 3D-printing, be it a layer 1 or a valve 20 of the fluid storage tank 100. The fluid storage tank 100 comprises a single layer 1, which encloses a chamber 10a. An interior of the chamber 10a is connected to an exterior of the chamber 10a via a valve 20. In this way, fluid (not shown) can easily be filled into the chamber 10a of the fluid storage tank 100 and be removed from the chamber 10a of the fluid storage tank 100. The single layer 1 provides both stability and ability to store the fluid within the chamber 10a in a safe way. The valve 20 represents both an intake port and an exhaust port for the fluid to be filled into and/or to be let out from the chamber 10a.

The valve 20 can be built as a manually operated valve or as an electrically operated valve or as a hydraulically operated valve. In this way, various possibilities exist to provide means to fill, refill and empty the chamber 10a of the fluid storage tank 100. For example, the valve 20 can be designed to be controlled via cable or a wireless connection, so that also a remote operation (e.g. via radio signals) of the valve 20 is possible.

FIG. 2 shows a cross sectional view of a further embodiment of the proposed fluid storage tank 100. In this embodiment the layer 1 is formed by two layers, in more detail a first layer 1a, which provides stability and a second layer 1b, which provides the ability to store fluid within the chamber 10a of the tank 100. To this end, the second layer 1b provides smaller pores compared to pores of the first layer 1a. For example, a material of the second layer 1b has a greater density than a material of the first layer 1, in this way, pores of the second layer 1b can prevent a leakage of the fluid being filled within the chamber 10. Both layers 1a, 1b are at least partially, preferably completely arranged on top of each other. Thus, a reinforced layer with two layers 1a, 1b is provided in order to store the fluid within the chamber 10a in a reliable way.

Referring now to FIG. 3, one can see that a further embodiment of the proposed 3D-printed fluid storage tank 100 provides several chambers 10a . . . 10n, which are interconnected via interconnection lines 30a . . . 30n. The interconnection lines 30a . . . 30n can be made by 3D-printing. In this manner, the volumes of all chambers 10a . . . 10a establish a total volume of the fluid storage tank 100 into which the fluid can be filled, refilled and emptied via the valve 20. In other words, the chambers 10 . . . 10n form numerous connected “sub-tanks”, which are combined together to establish an “overall tank”. Fluid within the chambers 10a . . . 10n can therefore stay in fluid communication, so that the fluid can be filled into and/or refilled into and/or emptied from the whole fluid storage tank 100 by means of the valve 20 in a defined direction.

With reference to FIG. 4 a structural detail is shown, by means of which the valve 20 can be fixed to the fluid storage tank 100. The thread 2 can also be built in the single layer 1 of the embodiment of FIG. 1. The first layer 1a and the second layer 1b can at least be partially 3D-printed, such that an appropriate thread 2 for a thread of the valve 20 is formed. By means of said thread 2, the valve 20 (not shown) can be screwed into the thread 2 and out of the thread 2, e.g. replaced, e.g. if the valve 20 is defective.

Alternative embodiments, which are not shown in figures, envisage that at least one of the valves 20 can be connected to the fluid storage tank 100 via a glue or can integrally be formed within the layers 1, 1a, 1b. Hence, numerous alternatives are provided to realize a valve 20 and to connect the valve 20 functionally between an exterior and an interior (chamber 10a . . . 10n) of the fluid storage tank 100.

According to yet another embodiment, which is shown in principle in FIG. 5, there is proposed a digital membrane 3, which is at least partially arranged between the first layer 1a and the second layer 1b. The digital membrane 3 can be equipped with several electronic (e.g. analog and digital) components and elements (not shown), e.g. electrically conductive traces, strain gauges, electronic circuitry, etc. Thereby, by means of the digital membrane 3 it is possible to measure various physical parameters, such as pressure, force, temperature, tension, etc. The digital membrane 3 can thus be used to provide useful data regarding a mechanical condition of at least a portion between the layers 1a, 1b.

In yet another embodiment, at least one of the before mentioned elements of the digital membrane 3 provides an electric control signal for an electric driven valve 20. In this way, a filling of the chamber 10a can be monitored via a mechanical deformation of the second layer 1b and a corresponding signal which is generated e.g. by a strain gauge provided by the digital membrane 3 to the electric driven valve 20.

FIG. 6 shows a cross-sectional view of a further embodiment of the proposed fluid storage tank 100. This embodiment is characterized in that it provides an enforcing structure 40 with enforcing elements 41, which are at least partially arranged between the first layer 1a and the second layer 1b, for example in the form of a stabilizing skeleton. In this way, a stability of the whole arrangement of the fluid storage tank 100 can be further improved. For example, the enforcing structure 40 can be integrally and/or discrete formed with the layers 1a, 1b and can in this way be made within a manufacturing process of the fluid storage tank 100.

By means of the enforcing structure 40, a damaging effect of a damaged first layer 1a, resulting in a reduced stability, can be minimized. As a consequence, by means of the enforcing structure 40, a fluid can be better protected within the chamber 10a of the fluid storage tank 100. Improved longevity is thus resulting therefrom.

Referring to FIG. 7 now, one can see a top view of an exemplary enforcing structure 40, wherein the enforcing elements 41 are honey-combed. As a result of this shaping, said enforcing structure 40 can easily be 3D-printed and provides an optimized stability of the fluid storage tank 100. Also numerous alternative shapings of the enforcing structure 40 with the enforcing elements 41 are possible.

For example, discrete enforcing structure 40 can be provided, which can be fixed between the first and the second layer 1a, 1b during a manufacturing process of the 3D-printed tank 100. In this way, numerous forms and materials are imaginable for the sake of further improvement of the stability of the fluid storage tank 100.

In yet another embodiment (not shown in figures), a digital membrane 3 can be arranged between the enforcing structure 40 and at least one of the layers 1a, 1b. In this way, a damaged enforcing structure 40 and/or damaged enforcing elements 41 can be recognized and a corresponding status can signalled by means of a component of the digital membrane 3, for example wireless to an external control device (not shown).

FIG. 8 shows a principle cross-sectional view of yet another embodiment of the proposed fluid storage tank 100. In this embodiment one or more baffle plates 4a . . . 4n are provided to separate the chambers 10a . . . 10n at least partially from each other. This can be useful, for example if the fluid storage tank 100 is used in a vehicle for a transportation of a liquid fluid.

As an effect of said baffle plates 4a . . . 4n, the vehicle with the 3D-printed tank 100 is prevented as far as possible from being moved in case that the vehicle stops or accelerates with a greater amount of liquid fluid being inside the chambers 10a . . . 10n of the fluid storage tank 100.

Hence, by means of said baffle plates 4a . . . 4n, the fluid can be kept stabilized as far as possible in the chambers 10a . . . 10n during transportation. This can be useful in transport situations, e.g. by means of motor vehicles, aircrafts, submarines, ships, etc.

FIG. 9 shows a cross-sectional view of a further embodiment of the proposed fluid storage tank 100. It can be seen that in this embodiment a structure of the interconnection lines 30a . . . 30n between the chambers 10a . . . 10n is irregular. Resulting therefrom, a defined flow direction of the fluid within the chambers 10a . . . 10n can be avoided as far as possible. In this way, indefinite movements of fluids within the chambers 10a . . . 10n of the fluid storage tank 100 can be avoided as far as possible. Thereby, similar to the embodiment with the baffle plates 4a . . . 4n, the irregular structure of the connection lines 30a . . . 30n can improve a mechanical stability of the 3D-printed tank 100 with filled-in liquid fluid during transportation.

Furthermore, by means of such irregularly connected chambers 10a . . . 10n, a leakage of fluid in one single go can be prevented as far as possible. Also a small number of leakages leave the main structure of the fluid storage tank 100 more or less intact, even if a damaging event, e.g. fire, earthquake, etc. has taken place.

A further embodiment of the proposed fluid storage tank 100 proposes, that the fluid-tight second layer 1b is self-healing. In this way, a breakage in the second layer 1b can be repaired, due to the self-healing effect. In this way, the second layer 1b can prevent a leakage of fluid out of the chambers 10a . . . 10n. In this way, an enhanced stability and long-life of the proposed fluid storage tank 100 is supported.

According to a further embodiment, the first layer 1a is made of a metallic material.

According to a further embodiment, the second layer 1b is made of synthetic material, preferably a material which is tension-proof, e.g. resin or the like.

Referring now to FIG. 10, it can be seen that at least two chambers 10a and 10c of the fluid storage tank 100 are connected by means of a bridging line 31. Said bridging line 31 can be useful in a case that the chamber 10b gets damaged or is leaking. In this case the fluid flow can be conducted via the bridging line 31 from chamber 10a to chamber 10c, thus minimizing a performance loss of the whole fluid storage tank 100.

In the following, some useful applications of proposed at least partially via 3D-printing made fluid storage tanks 100 are illustrated in more detail by way of example.

FIG. 11 shows in principle a perspective sectional view of a further embodiment of a proposed fluid storage tank 100. It can be seen that a lower section of a fluid storage tank 100 is formed transportable, e.g. as a vehicle with wheels 51. In this embodiment, the fluid storage tank 100 is driveable with wheels 51 and a drawbar 50. Connection lines 30a, 30b connect chambers (not shown) of the fluid storage tank 100. In this way, the fluid storage tank 100 can be transported on overland tours. Shipping procedures and/or transportations by air of the fluid storage tank 100 can therefore thus be reduced as far as possible.

FIG. 12 shows a cross-sectional of another embodiment of the proposed fluid storage tank 100. One can see, that the fluid storage tank 100 comprises a sealing member 5, by means of which an opening of the tank 100 can be opened or closed. The sealing member can be formed as a screw cap, which comprises a thread and can be screwed in a thread of the layers 1a, 1b. This can for example be useful, if any solid fluid (e.g. ice) is filled into the chamber 10a. In this way, greater amounts of the solid fluid can be filled in and also removed from the tank 100. In an alternative, it is possible that also an additional valve 20 (not shown) is arranged within the layers of the fluid storage tank 100.

Possible geometric forms of the proposed fluid storage tank 100 are numerous, they can e.g. be built cylindrical, cubical, cuboidal, etc. which is indicated with respect to FIG. 13.

FIG. 13 shows top views of three geometrically different embodiments of the proposed fluid storage tank 100. One can see a cubical (left side), cuboidal (central) and cylindrical form (right side). Although not shown in figures, there are possible numerous additional geometrical forms for the fluid storage tank 100.

Referring to FIG. 14 now there is shown another embodiment of the proposed fluid storage tank 100. In this embodiment, the fluid storage tank 100 is embodied in a wing of an aircraft. Thereby, the first layer 1a and the second layer 1b are shaped such that the chambers 10a . . . 10n are formed inside the wing of the aircraft. In this way, for example a hydrogen powered aircraft can be realized, which uses pressurized hydrogen fuel as a power source wherein the hydrogen is stored in the chambers 10a . . . 10n of the fluid storage tank 100. The hydrogen can either be burned in a jet engine, or other kind of internal combustion engine, or can be used to power a fuel cell to generate electricity to power a propeller. Such aircrafts can be realized e.g. as personal air vehicles.

Also a digital membrane 3 can be arranged inside the wing. By means of said digital membrane 3 mechanical tensions, mechanical forces, temperatures, etc. can be measured, thereby providing a feedback about physical parameters of the aircraft and/or the environment during a flight. In this way, a number of measuring devices to measure said parameters can be minimized.

FIG. 15 shows a front view of an aircraft with two proposed fluid storage tanks 100. Also the fuselage or the other frame of the aircraft can store pressurized hydrogen gas by means of the proposed fluid storage tank 100.

FIG. 16 shows a further embodiment of the proposed fluid storage tank 100 in a form of a drone box for parking a drone (not shown). The chambers 10a . . . 10n of the drone box can be filled with a liquid fluid, wherein the chambers 10a . . . 10n are at least partially connected with each other by connection lines 30a . . . 30n. In this way, the drone box can for example heated or cooled by the filled-in fluid, e.g. water. This can be useful, for example in cold regions, where a battery of the drone needs to be loaded under defined temperature conditions, for example at room temperature.

In this way, a lightweight-constructed drone box can easily be transported to a planned location and can there be filled with the cooling/heating-medium.

Furthermore, in hot environments, the filled-in fluid can be used to cool the inside of the drone box in order to support an improved functionality, e.g. data transfer of collected data during flight of the drone inside the drone box.

Another application of the proposed fluid storage tank 100 can for example be a facade cladding at a housing to isolate the building with the liquid being filled in the fluid storage tank 100. For example, also a digital membrane 3 can be arranged between the layers 1a, 1b of the fluid storage tank 100.

For example, a drone which has been parked in a drone box of FIG. 16 is operated by a drone-pilot to take photos of the exterior of the housing can localize its position in relation to the fluid storage tank 100 being realized as a facade cladding. To this end, the drone can emit a laser pulse to the fluid storage tank 100 with the digital membrane 3.

As a consequence, the digital membrane 3 is locally heated via the laser pulse and can indicate a location at the digital membrane 3. In this way a position of the digital membrane 3 vis-à-vis the drone, i.e. a position of the drone vis-à-vis the building can be determined. Hence, a real-time data communication regarding the position of the drone can be realized by means of the digital membrane 3, thus improving a knowledge of a position of the drone in relation to the building.

In this way the drone is in a better knowledge of its position vis-à-vis the building which can be measured or photographed via the drone during flight.

A fluid storage tank being realized as a facade cladding can also be used for a measurement of heating conditions at the façade and can therefore be used to control cooling means, for example window lamellas of the building.

Referring now to FIG. 17 there is shown a cross-sectional view of a further embodiment of a fluid storage tank 100 with separated chambers 10a, 10b. In this way, e.g. different types of fluids can be prevented from being intermixed during storage in a single fluid storage tank 100. To this end, they are separated per chamber 10a, 10b, wherein each fluid can individually be filled, refilled or emptied with respect to the chambers 10a, 10b. Also more than two separated chambers 10a, 10b are possible, e.g. each chamber 10a, 10b having more than one layer 1. In this way a concept of “stacked tanks” can be realized.

The fluid storage tank 100 forms in this way a block with several separate chambers 10a . . . 10n. The fluid storage tank 100 can thus be stacked vertically to increase storage size with minimized volume, wherein neighbouring tanks will not connect and share liquid contents.

The at least partially via 3D-printing manufactured fluid storage tanks 100 of the figures have been explained by way of illustration only. Needless to say that a fluid storage tank 100 according to the present specification can comprise more or less or other components than explained and/or shown in the figures.

The number of chambers 10a of the described embodiments is provided by way of example only. That means, that the proposed fluid storage tank 100 can comprise an optimized number of chambers 10a . . . 10n which can at least partly be interconnected between each other via connection lines 30a . . . 30n, bridging lines 31, etc.

The fluid storage tank 100 can be produced cost-effective compared to tanks produced of composite materials. Therefore the proposed 3D-printed tank 100 can be built of less material with less weight. In this way, an improved handling and a cost effective production of the fluid storage tank 100 is supported.

Exemplary advantages of the proposed fluid storage tank 100 according to the present specification include inter alia:
Improved stability
Improved flexibility and modularity
Weight saving
Improved corrosion resistance
Structural rigidity and durability
Cost-efficient production
Numerous fields of application
Ease of assembly
Ease of transportability to different locations

A transport of liquids can be safe and convenient performed with the proposed fluid storage tanks 100. By means of the proposed 3D-printed fluid storage tank 100 both hazardous and non-hazardous fluids can be stored and/or transported. The proposed 3D-printed fluid storage tanks 100 are e.g. corrosion-resistant, lightweight and durable and involve also non-flammable materials which can resist high temperatures. By means of the proposed 3D-printed fluid storage tank 100, timber, concrete, steel, etc. can be replaced with lighter and stronger, smarter and price competitive materials. Useful applications for the proposed tank 100 can for example be realized in the area of aerospace.

For example, disclosed elements of the fluid storage tank can be combined in a variety of ways, such that numerous embodiments are realizable within the scope of the present application.

Therefore, a skilled person can recognize that numerous variations are possible which are not or not fully disclosed hereinbefore.

### REFERENCE LIST

1 layer
1a 1^{st} layer
1b 2^{nd} layer
2 thread
3 digital membrane
4a . . . 4n baffle plate
5 scaling means
10a . . . 10n chamber
20 valve
30a . . . 30n connection line
31 bridging line
40 enforcing structure
41 enforcing element
50 drawbar
51 wheel
100 fluid storage tank

1. Fluid storage tank, comprising at least one layer, wherein the at least one layer encloses at least one chamber, further comprising a valve, the valve connecting an interior of the at least one chamber with an exterior of the at least one chamber, wherein the fluid storage tank is made at least partially by means of 3D-printing.

2. Fluid storage tank according to claim 1, comprising at least two layers, wherein the layers are at least partially arranged on top of each other, wherein a first layer provides stability and a second layer provides tightness for a fluid.

3. Fluid storage tank according to claim 1, comprising a defined number of chambers greater than one, wherein the chambers are separated from each other or are at least partially connected with each other by connection lines.

4. Fluid storage tank according to claim 1, wherein the valve is 3D-printed.

5. Fluid storage tank according to claim 1, further comprising a thread for fixing the valve.

6. Fluid storage tank according to claim 1, wherein the valve is glued in an opening of the at least one layer.

7. Fluid storage tank according to ene of claim 3, wherein the connection lines between the chambers are irregularly structured.

8. Fluid storage tank according to claim 2 further comprising a digital membrane, which is at least partially arranged on at least one layer.

9. Fluid storage tank according to claim 8, wherein the valve is steerable via an electric signal provided by the digital membrane.

10. Fluid storage tank according to claim 2, wherein at least one of the layers comprises a metallic material or synthetic material, resin or the like.

11. (canceled)

12. Fluid storage tank according to claim 2, wherein the second layer is self-healing.

13. Fluid storage tank according to claim 2, comprising an enforcing structure being at least partially arranged on at least one layer.

14. Fluid storage tank according to claim 13, wherein the enforcing structure is a framework, is at least partially built discrete, and/or is at least partially formed integrally with the layers.

15. (canceled)

16. (canceled)

17. Fluid storage tank according to claim 13, wherein the enforcing structure is honey-combed.

18. Fluid storage tank according to claim 1 further comprising at least one baffle plate in at least one chamber.

19. Fluid storage tank according to claim 3 further comprising at least a sealing member for sealing at least one of the chambers.

20. Fluid storage tank according to claim 2, wherein the 3D-printed fluid storage tank is arranged in a vehicle, in an aircraft, or in a drone box.

21. (canceled)

22. Fluid storage tank according to claim 20, wherein the 3D-printed fluid storage tank is arranged in at least a wing of the aircraft.

23. Fluid storage tank according to claim 22, wherein the 3D-printed fluid storage tank comprises a digital membrane, which is at least partially arranged between the first layer and the second layer.

24. (canceled)

25. Fluid storage tank according to claim 1, wherein the 3D-printed fluid storage tank is at least partially arranged at a facade of a building.
